(19) United States
(12) Patent Application Publication
(10) Pub. No.: US 2017/0101178 A1
(43) Pub. Date: Apr. 13, 2017

(54) FLYING APPARATUS WITH MULTIPLE SENSORS AND GESTURE-BASED OPERATION

(71) Applicant: Hoi Hung Herbert LEE, Hong Kong (HK)

(72) Inventor: Hoi Hung Herbert LEE, Hong Kong (HK)

(21) Appl. No.: 14/877,830

(22) Filed: Oct. 7, 2015

(51) Int. Cl. B64C 39/02; B64C 27/08; B64D 47/08

(52) U.S. Cl. CPC B64C 39/024; B64D 47/08; B64C 27/08; B64C 2201/146; B64C 2201/108; B64C 2201/027

(57) ABSTRACT

According to embodiments of the disclosed technology, apparatuses and methods are provided for an unmanned flying craft that senses different aspects of its surroundings and adjusts flying patterns in response thereto. The apparatus may employ a plurality of sensors for detecting and receiving information and/or signals from locations surrounding the apparatus. The disclosed technology may employ sensors directed to receiving and translating hand gesture signals performed by a user. Moreover, other sensors may constantly monitor elevation and automatically control altitude based on elevation. Still further, proximity sensors may sense nearby obstacles to be avoided by the flying craft.

### FIELD OF THE INVENTION

The present invention generally relates to flying apparatuses and more particularly to a flying apparatuses with one or more sensors for improving performance and reducing risk of damage.

### BACKGROUND OF THE INVENTION

Remote-control flying vehicles, also referred to as flying objects/drones or unmanned aerial vehicles (“UAVs”), are becoming increasingly more popular and sophisticated. While larger craft such as military and civilian drone aircraft have been in use for only the last two decades, smaller radio-controlled flying vehicles built and flown by hobbyists have been around for much longer. Generally, remote-control flying vehicles are either fixed wing, like a plane, or hovering, like a helicopter or quadcopter.

An unmanned vehicle, which may also be referred to as an autonomous vehicle, is a vehicle capable of travel without a physically-present human operator. An unmanned vehicle may operate in a remote-control mode, in an autonomous mode, or in a partially autonomous mode.

When an unmanned vehicle operates in a remote-control mode, a pilot or driver that is at a remote location can control the unmanned vehicle via commands that are sent to the unmanned vehicle via a wireless link. When the unmanned vehicle operates in autonomous mode, the unmanned vehicle typically moves based on pre-programmed navigation waypoints, dynamic automation systems, or a combination of these. Further, some unmanned vehicles can operate in both a remote-control mode and an autonomous mode, and in some instances may do so simultaneously. For instance, a remote pilot or driver may wish to leave navigation to an autonomous system while performing another task such as operating a mechanical system for picking up objects via remote control.

Various types of unmanned vehicles exist for various different environments. For example, unmanned vehicles exist for operation in the air, on the ground, underwater, and in space. Unmanned vehicles also exist for hybrid operations in which multi-environment use is possible. Examples of hybrid unmanned vehicles include an amphibious craft that is capable of operation on land as well as on water or a floatplane that is capable of landing on water as well as on land. Radio-controlled quadcopters or helicopters are popular amongst consumers and recreational enthusiasts. In principle, quadcopter is lifted and propelled by four rotors. A quadcopter is multi-rotor copter with four arms, each of which has a motor and a blade at their ends. Quadcopters are similar to helicopters in some ways, though their lift and thrust comes from four blades, rather than just one. Also, helicopters have a “pitch” or tail rotor that helps stabilize the craft, whereas quadcopters do not.

One example of a smaller, hovering type craft uses a hover control system in combination with a hand-held controller to cause the craft to mimic the orientation of the controller in terms of yaw, pitch, roll, and lateral flight maneuvers. Other examples of quadcopters utilize a Wi-Fi connection between the quadcopter and a smart phone or tablet that serves as a tilt-based remote control. Still other examples are controlled via a conventional dual joystick remote control. These kinds of electronically stabilized hovercraft or quadcopter designs with three or more separate rotors are generally more stable and easier to learn to fly than the single shaft, dual counter-rotating rotor, model helicopters that may use some form of mechanical gyro stabilization.

Flying toys, regardless of whether they are planes, helicopters, or quadcopters, are not easy to maneuver, especially for children and beginners. Existing helicopters having automatic altitude control capability, in which some elevation sensors are used to determine the current height of the flying apparatus from the ground. Typically, infrared red (IR) technologies are used to detect and control the altitude of the flying apparatus, in order to provide a more enjoyment experience for the user.

A problem with current designs for these kinds of smaller, hovering remote-control flying craft is that the competing design considerations of weight, cost and performance have resulted in a very limited set of designs for how these craft are constructed. The design of the single-shaft model helicopters has the dual counter-rotating rotors on the top of the craft where they are exposed to obstacles both above and to the sides of the rotors. Running the rotors into an obstacle, like a ceiling when flying indoors, almost always causes the craft to crash and potentially suffer damage as a result.

The design of most quadcopters utilizes a cross configuration formed of very stiff, carbon-fiber rods that hold the motors away from the center of the craft. Stiff carbon-fiber rods are used to minimize the torsion and vibration that occurs in a quadcopter design when the motors are not mounted in the center of gravity of the craft as is done in a single-shaft, counter-rotating helicopter design. These existing designs for smaller, hovering remote-control flying craft suffer from various problems, including cost of manufacture, ease of operation, accuracy of navigation, durability, and safety during operation, among others problems. There is a need for an inexpensive, yet robust design for a smaller, hovering remote-control flying craft.

Other technologies exist in other fields which may be beneficial to flying craft. For example, proximity sensing technologies may be used to detect the distance between one object and another. Proximity sensors are readily available in the market and some deployment of these technologies may be found in toys and electronic gadgets; particularly in moving objects where proximity sensors can be used to avoid obstructions.

Wireless gesture control is also gaining popularity with regard to video games, virtual reality and endless other applications. However, wireless gesture control, proximity sensing technologies, and altitude control capability are yet to be successfully implemented into remote flying craft. It is desirable, therefore, to define a platform that is capable of supporting these features effectively.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

### SUMMARY OF THE INVENTION

According to embodiments of the invention, apparatuses and methods are provided for an unmanned flying craft that senses different aspects of its surroundings and adjusts flying patterns in response thereto. The apparatus may employ a plurality of sensors for detecting and receiving information and/or signals from locations surrounding the apparatus. The disclosed technology may employ sensors directed to receiving and translating hand gesture signals performed by a user. Moreover, other sensors may constantly monitor elevation and automatically control altitude based on elevation. Still further, proximity sensors may sense nearby obstacles to be avoided by the craft.

In one embodiment of the disclosed technology, a flying object has one or more support structures for supporting hand gesture functions, automatic altitude control, and obstacle detection through proximity sensing. The flying object employs one or more of the following components: a) a main body; b) at least one flying arm connected to the main body; c) at least one blade connected to the flying arm; d) a rotor attached to the blade; e) a hand gesture sensor for a user to control flying patterns of the flying object; f) a proximity sensor configured to detect any obstacles near the flying object; g) a height sensor disposed on the flying arm for determining the altitude of the flying object; h) a charger adapter; and/or i) a controller to coordinate activities among the hand gesture sensor, the proximity sensor, and the height sensor. The bottom of the main body may have an adapter for connecting accessories, such as, for example, a camera. The hand gesture sensor may be composed of the hand gesture sensor includes a hand gesture emitter (51) and a hand gesture receiver (52), the hand gesture emitter emitting configured to signal to the user and the hand gesture receiver configured to receive signals represented by hand gestures performed by the user.

In a further embodiment of the disclosed system, a motor may be disposed on the flying object. A power source may also be employed to power the motor and other actions of the flying object. A second flying arm may extend from the body in a perpendicular orientation with respect to the first flying arm. The bottom sides of the first flying arm and the second flying arm may form to define a planar surface which has a downward curvature. One or more of the proximity sensors may be disposed on this planar surface. The proximity sensors may further be oriented at a 45 degree angle with respect to the horizontal axis. The proximity sensor may also be oriented at a 45 degree angle with respect to the bottom vertical axis.

In still further embodiments of the disclosed flying object, a camera may be coupled to the adapter. The camera may be attached via a movable structure that is a sliding structure configured to slide the camera along the main body, the first flying arm and/or the second flying arm. The movable structure may be a sliding structure that is configured to slide the camera along the main body, the first flying arm, and the second flying arm. The camera may also be movable to other areas or portions of the flying object by way of the sliding structure if it is detected by the controller that camera is blocking or obstructing any of the sensors or the views of the sensors.

A better understanding of the disclosed technology will be obtained from the following brief description of drawings illustrating exemplary embodiments of the disclosed technology.

### BRIEF DESCRIPTION OF THE DRAWINGS

FIG. 1 shows a plane view of a flying object according to embodiments of the disclosed technology.

FIG. 2 shows the opposing side of the flying object of FIG. 1 according to embodiments of the disclosed technology.

FIG. 3 is a high-level block diagram of a microprocessor device that may be used to carry out the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

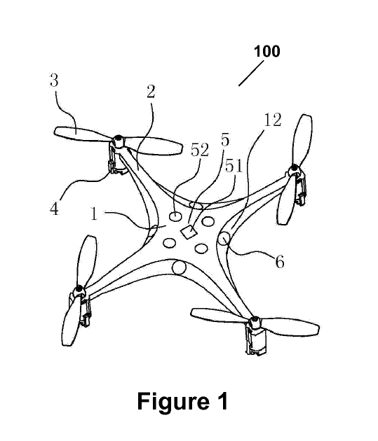

Referring now to FIG. 1, a flying object is depicted according to an embodiment of the disclosed technology. The terms “flying object” and/or “unmanned aerial vehicle,” (“UAV”) as used in this disclosure, refer to any autonomous or semi-autonomous vehicle that is capable of performing some functions without a physically-present human pilot. The terms “flying object”, “flying apparatus” and/or “unmanned aerial vehicle” may be used interchangeably throughout this specification and should not be understood to be different from one another unless otherwise described. Examples of flight-related functions may include, but are not limited to, sensing its environment or operating in the air without a need for input from an operator, among others.

A UAV may be autonomous or semi-autonomous. For instance, some functions could be controlled by a remote human operator, while other functions are carried out autonomously. Further, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from the one end of a street to another), while the UAV's navigation system autonomously controls more fine-grained navigation decisions, such as the specific route to take between the two locations, specific flight controls to achieve the route and avoid obstacles while navigating the route, and so on. Other examples are also possible.

A UAV can be of various forms. For example, a UAV may take the form of a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, and/or an ornithopter, among other possibilities. Further, the terms “drone”, “unmanned aerial vehicle system” (“UAVS”), or “unmanned aerial system” (“UAS”) may also be used to refer to a UAV.

FIG. 1 is a simplified illustration of a flying object according to an embodiment of the disclosed technology. In particular, FIG. 1 shows an example of a rotorcraft 100 that is commonly referred to as a multicopter. Multicopter 100 may also be referred to as a quadcopter, as it includes four rotors 4. It should be understood that example embodiments may involve rotorcraft with more or less rotors than multicopter 100. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to multicopter 100 in greater detail, the four rotors 4 provide propulsion and maneuverability for the multicopter 100. More specifically, each rotor 4 includes blades 3 that are attached to a motor. Configured as such the rotors 4 may allow the multicopter 100 to take off and land vertically, to maneuver in any direction, and/or to hover. Furthermore, the pitch of the blades 3 may be adjusted as a group and/or differentially, and may allow a multicopter 100 to perform three-dimensional aerial maneuvers such as an upside-down hover, a continuous tail-down “tic-toc,” loops, loops with pirouettes, stall-turns with pirouette, knife-edge, immelmann, slapper, and traveling flips, among others. When the pitch of all blades 3 is adjusted to perform such aerial maneuvering, this may be referred to as adjusting the “collective pitch” of the multicopter 100. Blade-pitch adjustment may be particularly useful for rotorcraft with substantial inertia in the rotors and/or drive train, but is not limited to such rotorcraft

Additionally or alternatively, multicopter 100 may propel and maneuver itself adjust the rotation rate of the motors, collectively or differentially. This technique may be particularly useful for small electric rotorcraft with low inertia in the motors and/or rotor system, but is not limited to such rotorcraft.

Multicopter 100 also includes a central enclosure or body 1. The central enclosure may contain, e.g., control electronics such as an inertial measurement unit (IMU) and/or an electronic speed controller, batteries, other sensors, and/or a payload, among other possibilities. The multicopter 100 may also have landing gear (not shown) to assist with controlled take-offs and landings. In other embodiments, multicopters and other types of UAVs without landing gear are also possible. Flying arms 2 connect the rotors 4 to the main body 1. The joining of the flying arms 2 to the body 1 defines a curved side-wall 12 of the body on which one or more of the preceding sensors may be disposed.

In a further aspect, multicopter 100 may have rotor protectors. Such rotor protectors may serve multiple purposes, such as protecting the rotors 4 from damage if the multicopter 100 strays too close to an object, protecting the multicopter 100 structure from damage, and protecting nearby objects from being damaged by the rotors 4. It should be understood that in other embodiments, multicopters and other types of UAVs without rotor protectors are also possible. Further, rotor protectors of different shapes, sizes, and function are possible, without departing from the scope of the invention.

A multicopter 100 may control the direction and/or speed of its movement by controlling its pitch, roll, yaw, and/or altitude. To do so, multicopter 100 may increase or decrease the speeds at which the rotors 4 spin. For example, by maintaining a constant speed of three rotors 4 and decreasing the speed of a fourth rotor, the multicopter 100 can roll right, roll left, pitch forward, or pitch backward, depending upon which motor has its speed decreased. Specifically, the multicopter may roll in the direction of the motor with the decreased speed. As another example, increasing or decreasing the speed of all rotors 4 simultaneously can result in the multicopter 100 increasing or decreasing its altitude, respectively. As yet another example, increasing or decreasing the speed of rotors 4 that are turning in the same direction can result in the multicopter 100 performing a yaw-left or yaw-right movement. These are but a few examples of the different types of movement that can be accomplished by independently or collectively adjusting the RPM and/or the direction that rotors 4 are spinning.

The flying apparatus 100 may be controlled, at least in part, by a remote device or controller. A remote device may take various forms. Generally, a remote device may be any device via which directional controls and other flying signals are transmit to the flying apparatus 100. For instance, a remote device may be a mobile phone, tablet computer, laptop computer, personal computer, or any network-connected computing device. Further, in some instances, remote device may not be a computing device. As an example, a standard telephone, which allows for communication via plain old telephone service (POTS), may serve as a remote device. Further, a standard joystick or other radio-controlled (“RC”) device may be used to communicate with the flying apparatus 100. Further, a remote device may be configured to communicate with access system via one or more types of communication network(s). For example, a remote device could communicate with access system (or via a human operator of the access system) by placing a phone call over a POTS network, a cellular network, and/or a data network such as the Internet. Other types of networks may also be utilized.

Referring still to FIG. 1, the body 1 of the apparatus 100 may have one or more sensors. A hand gesture sensor 5 may be disposed on an underbelly of the body 1. The hand gesture sensor 5 may be configured to receive signals sent by a human using their hands. The hand gesture sensor 5 may be any motion sensing input device known in the art. For example, the hand gesture sensor 5 may be one or more cameras configured to sense motion and perceive depth. The hand gesture sensor 5 may be composed of an RGB camera, depth sensor and multi-array microphone running proprietary software, which provide full-body 3D motion capture, facial recognition and/or voice recognition capabilities.

In further embodiments, the hand gesture sensor 5 may be composed of a hand gesture emitter 51 and a hand gesture receiver 52. The hand gesture emitter 51 may be used to emit signals to a user, such as by electronic signal, sound, light, and/or movement. The hand gesture receiver 52 would be the portion of the sensor 5 which would receive the signals outputted by the user.

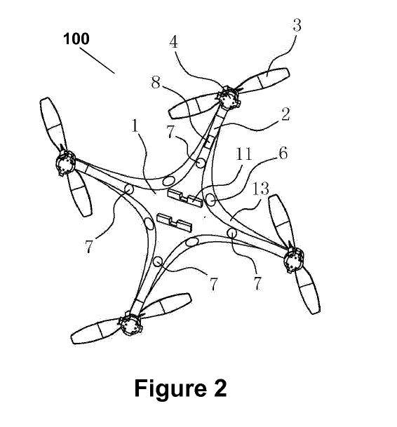

FIG. 2 shows the opposing side of the flying object of FIG. 1 according to embodiments of the disclosed technology. While the hand gesture sensor 5 may also be capable of detecting and computing depth, one or more height/depth sensors 7 may also be disposed in or on the apparatus 100. The depth sensors 7 may computer altitude and/or distance from the ground. The apparatus 100 may also have a proximity sensor 6. The proximity sensor 6 may be used to detect and avoid objects in the vicinity of the flying apparatus 100. The proximity sensor 6 may emit an electromagnetic field or a beam of electromagnetic radiation (infrared, for instance), and look for changes in the field or return signal. Different proximity sensor objects may demand different sensors. For example, a capacitive or photoelectric sensor might be suitable for a plastic target whereas an inductive proximity sensor always requires a metal target. The controller may be used to coordinate activities among the hand gesture sensor 5, the proximity sensor 6, and/or the height sensor 7. A downward curving planar surface 13 may form one or more sides of the body 1. In embodiments, the proximity sensor 6 may be disposed on or in this planar surface 13

Referring still to FIG. 2, a harness or adapter 11 may be disposed on the body 1 to couple an external accessory to the apparatus 100. The adapter 11 may be configured to receive, for example, a camera for taking photos and video during flights.

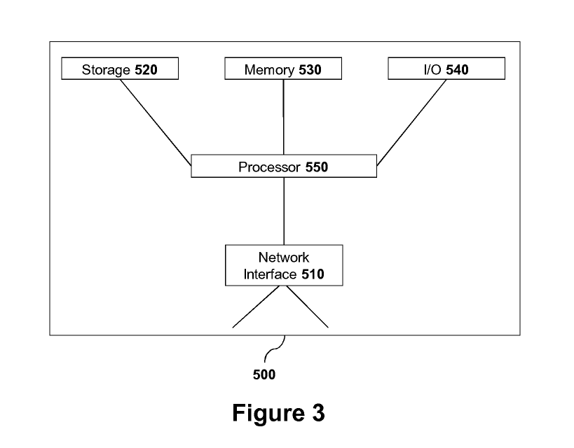

FIG. 3 is a high-level block diagram of a microprocessor device that may be used to carry out the disclosed technology. The device 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

One skilled in the art will recognize that an implementation of an actual device will contain other components as well, and that FIG. 3 is a high level representation of some of the components of such a device for illustrative purposes. It should also be understood by one skilled in the art that the method and devices depicted in FIGS. 1 and 2 may be implemented on a device such as is shown in FIG. 3.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

What is claimed:

1. A flying object comprising:
a main body (1);
a charger adapter (8);
at least one flying arm (2) connected to the main body;
at least one blade (3) connected to the flying arm;
a rotor attached to the blade (4);
a hand gesture sensor (5) for a user to control flying patterns of the flying object;
a proximity sensor (6) configured to detect any obstacles near the flying object;
a height sensor (7) disposed on the flying arm for determining the altitude of the flying object; and
a controller to coordinate activities among the hand gesture sensor, the proximity sensor, and the height sensor.

2. The flying object of claim 1, wherein a bottom of the main body has an adapter for connecting accessories.

3. The flying object of claim 2, wherein the hand gesture sensor includes a hand gesture emitter (51) and a hand gesture receiver (52), the hand gesture emitter emitting configured to signal to the user and the hand gesture receiver configured to receive signals represented by hand gestures performed by the user.

4. The flying object of claim 3, further comprising a power source to power a motor and other actions of the flying object.

5. The flying object of claim 4 further includes a second flying arm attached to the main body, wherein the second flying arm is perpendicular to the first flying arm.

6. The flying object of claim 5, wherein a bottom side of the first flying arm and the second flying arm defines a planar surface curving downward.

7. The flying object of claim 6, wherein the proximity sensor is placed on the planar surface (13) curving downward.

8. The flying object of claim 7, wherein the proximity sensor is oriented at a 45 degree angle from horizontal axis and at a 45 degree angle from the bottom vertical axis.

9. The flying object of claim 8, a camera is coupled to the adapter.

10. The flying object of claim 9, wherein the camera is connected to the main body through a movable structure that is configured to move along the main body, the first flying arm, and the second flying arm.

11. The flying object of claim 10, wherein the movable structure is a sliding structure that is configured to slide the camera along the main body, the first flying arm, and the second flying arm.

12. The flying object of claim 11, wherein the camera moves to other areas through the sliding structure when the controller detects that the camera's physical body is blocking the hand gesture sensor, the proximity sensor, or the height sensor.
